(19) United States
(12) Patent Application Publication
(10) Pub. No.: US 2018/0200794 A1
(43) Pub. Date: Jul. 19, 2018

(54) METHOD AND APPARATUS FOR OPTICAL DETECTION OF KEYHOLING AND OVERMELTS

(71) Applicant: GENERAL ELECTRIC COMPANY, Schenectady, NY (US)

(72) Inventor: Thomas Graham SPEARS, Springdale, OH (US)

(21) Appl. No.: 15/409,214

(22) Filed: Jan. 18, 2017

(51) Int. Cl. B22F 3/105; B33Y 10/00; B33Y 30/00; B33Y 40/00; B23K 26/03; B33Y 50/02; B23K 26/342; G01N 21/33; G01N 21/88

(52) U.S. Cl. CPC B22F 3/1055; B33Y 10/00; B33Y 30/00; B33Y 40/00; B23K 26/032; B22F 2998/10; B23K 26/342; G01N 21/33; G01N 21/88; B22F 2003/1057; B33Y 50/02

(57) ABSTRACT

Some aspects of the present disclosure provide a method of detecting defects in a continuous build process. The method includes applying a layer of powder to a build surface. The method includes fusing at least a portion of the powder layer to form a portion of a part. The method includes detecting a particular band of electromagnetic radiation produced by the fusing. In an aspect, the particular band of electromagnetic radiation is ultraviolet (UV) radiation.

### INTRODUCTION

The present disclosure generally relates to additive manufacturing using a laser powder bed process. More specifically, the disclosure relates to detecting keyholing and overmelts in a laser powder bed process.

### BACKGROUND

AM processes generally involve the buildup of one or more materials to make a net or near net shape (NNS) object, in contrast to subtractive manufacturing methods. Though “additive manufacturing” is an industry standard term (ASTM F2792), AM encompasses various manufacturing and prototyping techniques known under a variety of names, including freeform fabrication, 3D printing, rapid prototyping/tooling, etc. AM techniques are capable of fabricating complex components from a wide variety of materials. Generally, a freestanding object can be fabricated from a computer aided design (CAD) model. A particular type of AM process uses an energy beam, for example, an electron beam or electromagnetic radiation such as a laser beam, to sinter or melt a powder material, creating a solid three-dimensional object in which particles of the powder material are bonded together. Different material systems, for example, engineering plastics, thermoplastic elastomers, metals, and ceramics are in use. Laser sintering or melting is a notable AM process for rapid fabrication of functional prototypes and tools. Applications include direct manufacturing of complex workpieces, patterns for investment casting, metal molds for injection molding and die casting, and molds and cores for sand casting. Fabrication of prototype objects to enhance communication and testing of concepts during the design cycle are other common usages of AM processes.

Selective laser sintering, direct laser sintering, selective laser melting, and direct laser melting are common industry terms used to refer to producing three-dimensional (3D) objects by using a laser beam to sinter or melt a fine powder. For example, U.S. Pat. No. 4,863,538 and U.S. Pat. No. 5,460,758 describe conventional laser sintering techniques. More accurately, sintering entails fusing (agglomerating) particles of a powder at a temperature below the melting point of the powder material, whereas melting entails fully melting particles of a powder to form a solid homogeneous mass. The physical processes associated with laser sintering or laser melting include heat transfer to a powder material and then either sintering or melting the powder material. Although the laser sintering and melting processes can be applied to a broad range of powder materials, the scientific and technical aspects of the production route, for example, sintering or melting rate and the effects of processing parameters on the microstructural evolution during the layer manufacturing process have not been well understood. This method of fabrication is accompanied by multiple modes of heat, mass and momentum transfer, and chemical reactions that make the process very complex.

FIG. 1 is schematic diagram showing a cross-sectional view of an exemplary conventional system 100 for direct metal laser sintering (DMLS) or direct metal laser melting (DMLM). The apparatus 100 builds objects, for example, the part 122, in a layer-by-layer manner by sintering or melting a powder material (not shown) using an energy beam 136 generated by a source such as a laser 120. The powder to be melted by the energy beam is supplied by reservoir 126 and spread evenly over a build plate 114 using a recoater arm 116 travelling in direction 134 to maintain the powder at a level 118 and remove excess powder material extending above the powder level 118 to waste container 128. The energy beam 136 sinters or melts a cross sectional layer of the object being built under control of the galvo scanner 132. The build plate 114 is lowered and another layer of powder is spread over the build plate and object being built, followed by successive melting/sintering of the powder by the laser 120. The process is repeated until the part 122 is completely built up from the melted/sintered powder material. The laser 120 may be controlled by a computer system including a processor and a memory. The computer system may determine a scan pattern for each layer and control laser 120 to irradiate the powder material according to the scan pattern. After fabrication of the part 122 is complete, various post-processing procedures may be applied to the part 122. Post processing procedures include removal of access powder by, for example, blowing or vacuuming. Other post processing procedures include a stress release process. Additionally, thermal and chemical post processing procedures can be used to finish the part 122.

The apparatus 100 is controlled by a computer executing a control program. For example, the apparatus 100 includes a processor (e.g., a microprocessor) executing firmware, an operating system, or other software that provides an interface between the apparatus 100 and an operator. The computer receives, as input, a three dimensional model of the object to be formed. For example, the three dimensional model is generated using a computer aided design (CAD) program. The computer analyzes the model and proposes a tool path for each object within the model. The operator may define or adjust various parameters of the scan pattern such as power, speed, and spacing, but generally does not program the tool path directly.

Keyholing is a process used in laser welding that results in deep penetrating welds. Keyholing occurs when using a high power density laser that vaporizes metal to form a deep tunnel. In contrast, conduction welding merely melts the metal so that heat from the weld is evenly distributed across the top layer of the metal.

Keyholing when utilizing a high density laser configuration can be particularly problematic with additive manufacturing processes which require a level of precision that is free from defects. One of the problems that can be seen with keyholing is that gas bubbles may form in the weld tunnel. When the metal vapors harden, they harden around the bubble, which leaves a hole or structural flaw in the metal part. In addition, using a laser of too high a density can cause the unmelted, or powder portion, of the build surface to melt. This is undesirable because it forms a tunnel below the surface of the part, which may be considered a structural flaw. Similar to keyholing, an overmelt occurs when a high density laser melts powder beneath an intended layer of powder.

Structural flaws from keyholing and overmelts often cannot be seen by an operator because they are either too small, but still significant, or are on an internal surface not visible to the operator. To detect flaws, a computerized tomography (CT) scan is often used to reveal any defects in the processed and manufactured part. If a defect is discovered, the part may be scrapped. This results in a significant amount of lost time and resources because the defect was left undiscovered until the part completed processing.

Therefore, it is difficult to detect the keyholing mode and overmelts in an additive manufacturing process when either occurs and before the part completes processing.

### SUMMARY

In an embodiment, the present invention relates to a method of detecting defects in a continuous build process. The method applies a layer of powder to a build surface. The method fuses at least a portion of the powder layer. The method detects a particular band of electromagnetic radiation produced by the fusing.

In another aspect, the present invention relates to an apparatus for detecting defects in a continuous build process, the apparatus includes a build surface for receiving a layer of powder. The apparatus includes a laser for fusing at least a portion of the powder layer. The apparatus includes a photodetector for detecting a particular band of electromagnetic produced by the fusing.

### BRIEF DESCRIPTION OF THE DRAWINGS

FIG. 1 is a schematic diagram showing an example of a conventional apparatus for additive manufacturing.

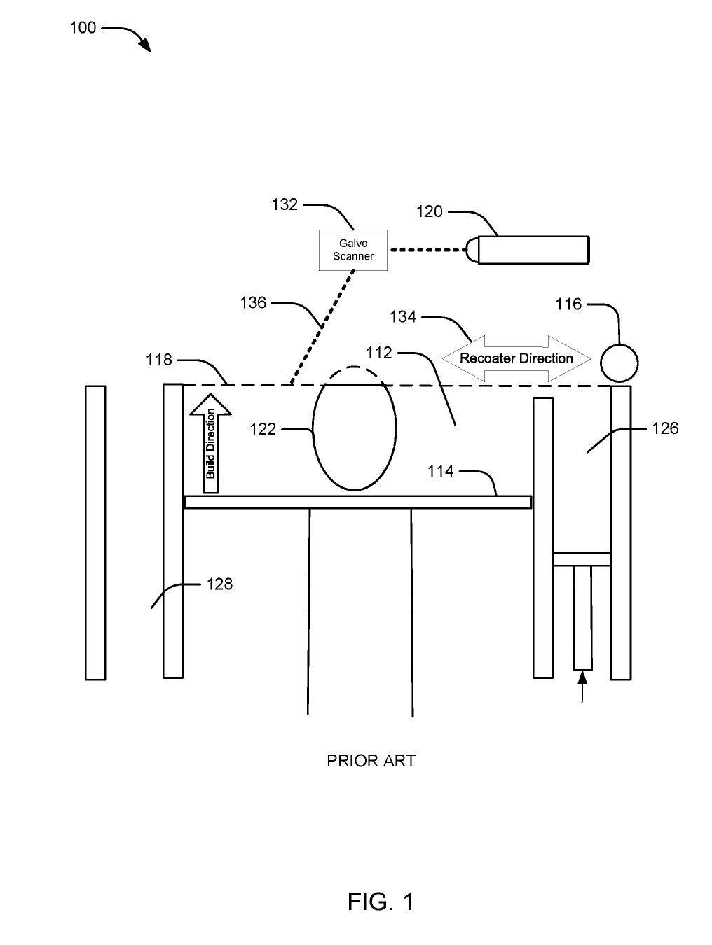

FIG. 2 illustrates a schematic diagram showing a cross-sectional view of an exemplary system for performing DMLS or DMLM according to an aspect of the disclosure.

FIG. 3 conceptually illustrates a process for detecting keyholing and overmelts according to an aspect of the disclosure.

FIG. 4 illustrates a diagram of a part that has developed an overmelt.

FIG. 5 illustrates a diagram of a system for detecting when the build process may be keyholing according to an aspect of the disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details.

The present invention improves techniques in the additive manufacturing (AM) process described above. Generally, a freestanding object can be fabricated from a computer aided design (CAD) model. A particular type of AM process uses an energy beam, for example, an electron beam or electromagnetic radiation such as a laser beam, to sinter or melt a powder material, creating a solid three-dimensional object in which particles of the powder material are bonded together. Different material systems, for example, engineering plastics, thermoplastic elastomers, metals, and ceramics are in use. Either laser sintering or melting are a notable AM processes for rapid fabrication of functional prototypes and tools. Applications include direct manufacturing of complex workpieces, patterns for investment casting, metal molds for injection molding and die casting, and molds and cores for sand casting. Fabrication of prototype objects to enhance communication and testing of concepts during the design cycle are other common usages of AM processes.

During the melting or sintering processes described above, it is usually desirable to avoid keyhole welding and downskin overmelts, which may cause a defect in the manufactured part that renders it unusable. Conduction mode and keyhole mode are two of the modes that may be realized during fusing. In conduction mode, the laser melts at least a portion of the powder bed. However, in keyhole mode, the laser causes the powder to go beyond its melting point and turn into plasma vapor. The plasma vapor emits radiation such as UV light, which may be detected by a photo sensor.

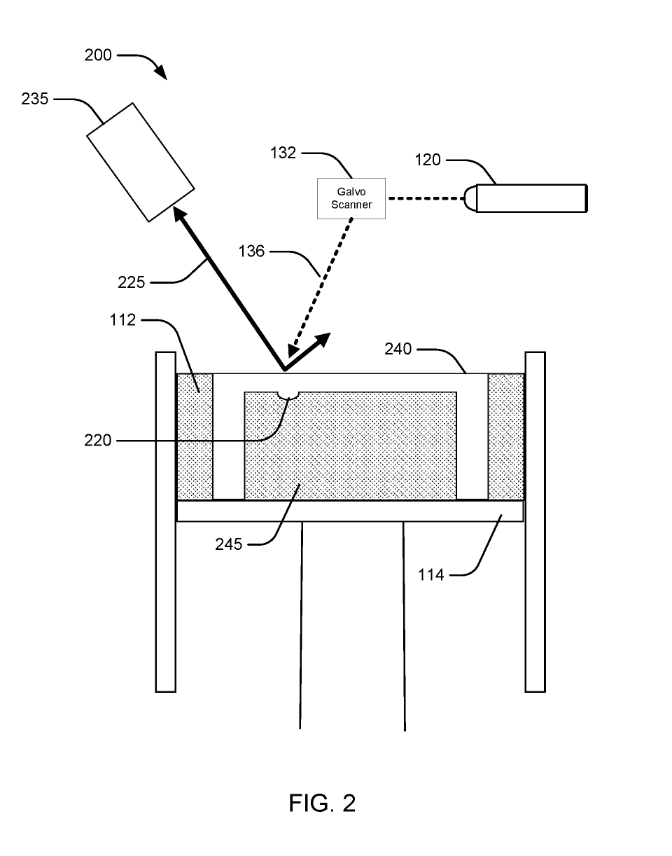

FIG. 2 illustrates a schematic diagram showing a cross-sectional view of an exemplary system 200 for performing DMLS or DMLM according to an aspect of the disclosure. As shown, the system 200 differs from the system 100 in that the system 200 incorporates a photosensor 235.

As shown, the system 200 includes a part 240 and unfused powder 245. In this diagram, the system 200 is in the process of manufacturing the part 240. However, the part 240 has developed an overmelted region 220. For example, the overmelted region 220 may be a tunnel or protrusion in the powder 245. The overmelt region 220 is formed as the result of the laser 120 causing a weld pool to penetrate deeper than expected. In other words, the laser has gone deep enough to fuse the unfused powder 245 in a region of the powder bed intended to remain unfused, causing a defect in the part 240. Such a defect may go undetected to an observer, for example, because the overmelt region 220 is shielded from view, yet ultimately may render the part unusable.

UV light 225 is emitted from the overmelt region 220 as a result of the powder being turned into plasma vapor. The UV light 225 may have a wavelength from 10 nm (30 PHz) to 400 nm (750 THz). The photosensor 235 is configured to detect a particular band of radiation such as the UV light and alert the operator to a potential presence of a defect in the part 240. Accordingly, the operator may learn of a defect expeditiously, stop the build process, and start building a new part. This significantly reduces waste and lost time caused by scrapping a part long after it has been processed.

In some aspects of the system, the photo sensor may continuously monitor the powder bed for UV radiation. However, one of ordinary skill in the art will appreciate that other bands of radiation may denote the presence of a structural defect and the photosensor may be calibrated accordingly to recognize such bands without departing from the scope of the invention. For example, in a thermoplastic system, certain bands of visible light may be indicative of a combustion mode, which may indicate a defect in the part.

In some aspects of the system, the photosensor may be a solid state semiconductor or photomultiplier tube capable of detecting particular bands of light such as UV light. The photosensor may include a focusing optic used to concentrate the light and/or a filtering optic to filter the impinging light. Such filtering optics may include bandpass, notch, short, and/or long pass filters. For example, the filtering optics may allow UV light having a wavelength from 10 nm (30 PHz) to 400 nm (750 THz) to pass.

In an ideal DMLS or DMLM build environment, no UV light would be present. Therefore, the detection of any amount of UV light would trigger the photosensor to alert the operator to a defect in the manufacturing process. As illustrated in FIG. 2, the photosensor is positioned mounted in the build chamber at an off axis reference frame. As a result, the photosensor is capable of monitoring the build chamber at all times, and particularly when the laser is operating. However, one of ordinary skill in the art will appreciate that the photosensor could be positioned with the laser (on-axis), so long as it is properly tuned for such positioning, without departing from the scope of the invention.

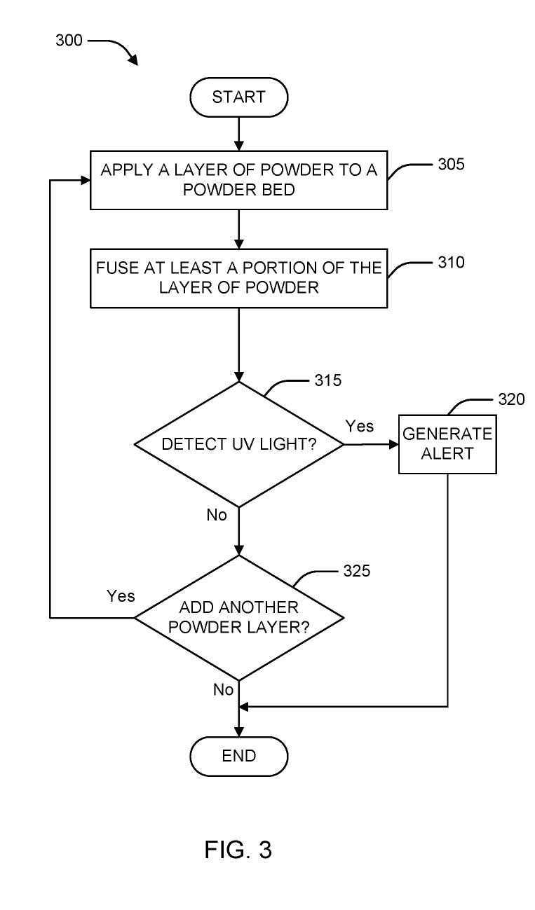

FIG. 3 is a flowchart conceptually illustrating a process 300 for detecting keyholing and overmelts. The process 300 may be performed by an AM system such as system 200. The process 300 may begin after the system 200 has received instructions to build a part.

As shown, the process 300 applies (at 305) a layer of powder to a powder bed. For example, a recoater 116 applies a layer of powder in the powder bed 112. At 310, the process includes fusing at least a portion of the layer of powder. The fusing may be accomplished by a laser 120 sintering or melting the powder. The process 300 includes detecting (at 315) the presence of any UV light. For example, the photosensor 235 detects light generated by the fusing process. If the photosensor 235 detects UV light, in block 315, the photosensor 235 may generate a signal. For example, the photosensor 235 may determine whether detected UV light satisfies a threshold (e.g., 1 mW/cm2). Such a presence may indicate a defect in the part or that the system is in keyholing mode rather than conduction mode.

When the photosensor 235 detects (at 315) the presence of UV light, the process 300 includes generating (at 320) an alert. Such an alert may be transmitted to an operator of the system so that the operator can determine whether to continue processing the part or scrap the part, thereby reducing cycle time. Generating the alert may also include pausing the build process, for example, between layers. If the operator determines to end the build process, the process 300 then ends. When the photosensor 235 does not detect (at 315) UV light, the process includes determining (at 325) whether another layer is to be added to the build surface. When the system 200 determines (at 325) that another layer of powder is to be added, the process 300 returns to 305 and the system 200 adds another layer of powder to the build surface. When the system 200 determines (at 325) that another layer of powder is not to be added to the build surface, the process 300 ends. At this point the part, such as part 240 has presumably been built without defect.

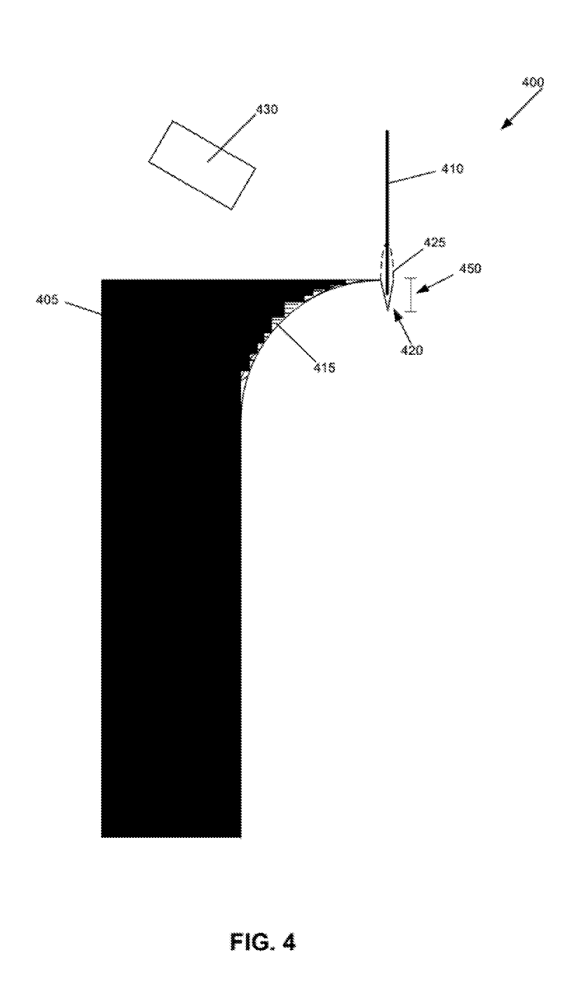

FIG. 4 illustrates a diagram 400 of a part that has developed an overmelt. The diagram 400 includes a photosensor 430 and a part 405, which may be manufactured using one of the AM processes described above. Although not shown, the part 405 is surrounded by powder, such as powder 245 on the sides and positioned on a build surface, such as the build surface 114.

As shown, the part 405 includes an arch 415, a downskin overmelt 420, UV radiation 425, and a laser beam 410. The downskin overmelt 420 may be of a determined size 450. In some aspects of the system, it may be possible to calibrate the photosensor 430 to map the size and shape of the overmelt 420. For instance, certain signal intensities generated from the detected UV light may be input into a formula, which outputs characteristics such as size (height and width) of the overmelt to the operator.

In order to gather accurate values, the photosensor 430 may be calibrated to different materials, which generate different intensities depending on the characteristics of the overmelt. The photosensor 430 may include a memory having preconfigured data acquired by causing an overmelt in a particular material, noting at least one characteristic of the overmelt (e.g., depth), noting the intensity of the detected UV light, and correlating the intensity with the characteristic of the overmelt. Materials that may be utilized in this system include, but are not limited to cobalt chrome (CoCr), Inconel 718, Inconel 625, and/or any other suitable material for laser welding.

The system is also capable of detecting keyholing. Keyholing is problematic because it may cause inclusions as the vaporized metal hardens over gas bubbles that may be formed as a result of keyholing (rather than conduction welding). The ability to detect keyholing may enable recalibration of the system before a serious defect causes the part to be scrapped.

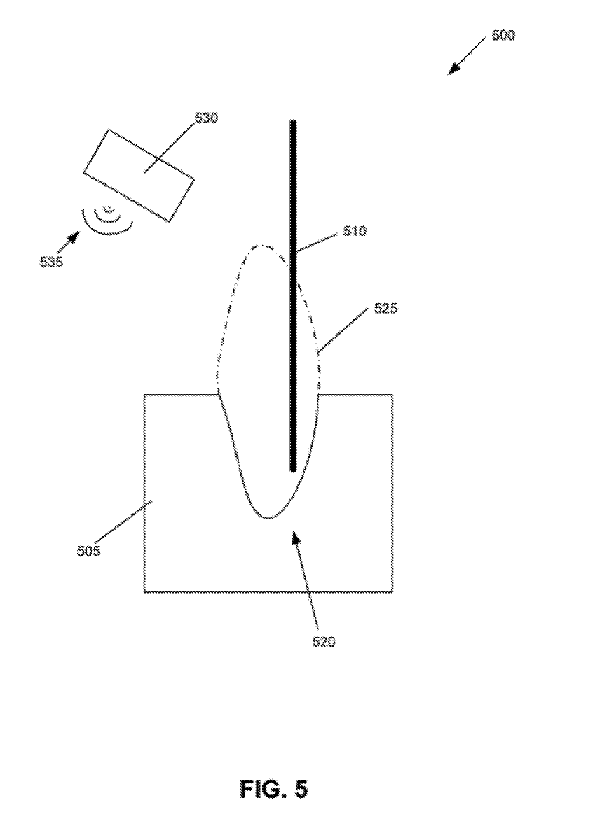

FIG. 5 illustrates a diagram of a system 500 for detecting when the build process may be keyholing. Keyholing varies slightly from overmelts in that the keyhole is formed in the melted region rather than the powder. The system 500 includes a photosensor 530, an alert 535, a beam 510, and a part 505. The part 505 includes a keyhole 520, and plasma vapor 525.

As shown, the beam 510, which may be a laser beam, has raised the temperature of the powder, not only to the melting point, but to such a temperature that the laser has vaporized at least some of the material in the melted region of the part 505. As a result, plasma vapor 525 is generated, which emits UV light. The UV light is detected by the photosensor 530 and an alert 535 is generated. As discussed above, the alert may notify the operator of a defect. The alert 535 may also be configured to alert the operator of at least one characteristic of the defect such as size. The operator may determine whether to stop the build process based on the alert. In another aspect, the system 500 may determine whether to stop the build process based on the alert or the characteristics of the defect.

This written description uses examples to disclose the invention, including the preferred embodiments, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims. Aspects from the various embodiments described, as well as other known equivalents for each such aspect, can be mixed and matched by one of ordinary skill in the art to construct additional embodiments and techniques in accordance with principles of this application.

1. A method of detecting defects in a continuous build process, the method comprising:
applying a layer of powder to a powder bed;
fusing at least a portion of the layer of powder to form a portion of a part; and
detecting a particular band of electromagnetic radiation produced by the fusing.

2. The method of claim 1, wherein the particular band of electromagnetic radiation is ultraviolet radiation.

3. The method of claim 1, further comprising generating an alert upon detecting the particular band of electromagnetic radiation.

4. The method of claim 3, further comprising stopping a build process in response to generating the alert.

5. The method of claim 1, wherein said detecting further comprises determining that an overmelt or keyholing operation has occurred.

6. The method of claim 5, wherein said detecting further comprises detecting a characteristic of the overmelt or keyhole formed by the fusing.

7. An apparatus for detecting defects in a continuous build process, the apparatus comprising:
a build surface for receiving a layer of powder;
a laser for fusing at least a portion of the powder layer; and
a photodetector for detecting a particular band of radiation produced by the fusing.

8. The apparatus of claim 7, wherein the particular band is ultraviolet (UV) radiation.

9. The apparatus of claim 7, wherein the photodetector comprises a solid state semiconductor.

10. The apparatus of claim 7, wherein the photodetector comprises a photomultiplier tube.

11. The apparatus of claim 7, wherein the photodetector comprises one of a bandpass, notch, short, and long pass optical filter tuned to the particular band of radiation.

12. The apparatus of claim 7, wherein the photodetector is configured to generate an alert upon detecting the particular band of radiation.

13. The apparatus of claim 12, wherein the apparatus is configured to stop the continuous build process in response to the alert.

14. The apparatus of claim 7, wherein the photodetector is further for detecting an overmelt or keyholing operation.

15. The apparatus of claim 14, where the photodetector is further for detecting a characteristic of the overmelt or keyhole formed by the overmelt or keyholing operation.

16. The apparatus of claim 7, wherein the photosensor is mounted on an off-axis frame.
